(19) United States
(12) Patent Application Publication
(10) Pub. No.: US 2008/0031698 A1
(43) Pub. Date: Feb. 7, 2008

(54) Cutting Insert Provided With Structured Surfaces

(75) Inventors: Reinhard Pitonak, Bruck/Mur (AT); Karl Kipperer, St. Michael (AT); Ronald Weissenbacher, Bruck/Mur (AT); Klaus Udier, Graz (AT)

Correspondence Address: GREENBLUM & BERNSTEIN, P.L.C., 1950 ROLAND CLARKE PLACE, RESTON, VA, 20191, US

(73) Assignee: BOEHLERIT GMBH & CO. KG., Kapfenberg (AT)

(21) Appl. No.: 11/572,352

(22) PCT Filed: Jun. 21, 2005
(86) PCT No.: PCT/AT05/00219

§ 371 Date: Mar. 2, 2007

(30) Foreign Application Priority Data
Jul. 22, 2004 (AT) A 1257/2004

(51) Int. Cl. B26D 1/00

(52) U.S. Cl. 407/113

(57) ABSTRACT

Cutting insert for tools for cutting workpieces or objects, including at least one cutting edge, at least one lateral surface, and at least one cutting face comprising a fine structure having convex and concave areas. Additionally, the convex and concave areas, have a depth T and are respectively spaced apart from one another by a spacing A greater than 0.1 mm and less than 1.0 mm.

### CROSS REFERENCE TO RELATED APPLICATIONS

The present application is a National Stage Application of International Application No. PCT/AT2005/000219 filed Jun. 21, 2005, which published as WO 2006/007607 A1 on Jan. 26, 2006, the disclosure of which is expressly incorporated by reference herein in its entirety. Further, the present application claims priority under 35 U.S.C. § 119 and § 365 of Austrian Application No. A 1257/2004 filed Jul. 22, 2004.

### BACKGROUND OF THE INVENTION

1. Field of the Invention

The invention relates to a cutting insert, in particular an indexable insert, preferably of hard metal or cement for tools for cutting workpieces or objects with at least one cutting edge with free surface(s) and/or lateral surface(s) and at least one cutting face.

2. Discussion of Background Information

In a modern machining or in a modern cutting procedure with high capacity of workpieces of metal, alloys or polyphase materials, tools are used with cutting components of sintered hard materials, in particular of sintered carbide phases. These cutting components are embodied as plates or indexable inserts, fixed in a clamp-type tool holder or tool part and generally have a surface coating of hard material(s), which coating can be embodied in a single layer or multiple layers and can be applied according to the CVD or PVD method.

An improved adhesion of the surface coating on the cutting insert can be achieved according to U.S. Pat. No. 5,722,803 by a surface roughness Ra of the substrate of between 15 and 125 microinches Ra.

One chip is respectively removed from the surface area of the workpiece by the tools, which chip is generally produced in a spiral form and optionally develops in this shape in an unbroken manner.

However, long spiral chips can be a serious impediment to the machining of the workpiece in the mechanical equipment, such as lathes and the like, which is why chips are preferred that break off short and that can be easily collected and removed in a simple manner.

In terms of alloy technology, an early chip break or the formation of short chips can be promoted in machining, e.g., by an increased sulfur and manganese content of the workpiece, because manganese sulfides can lead to the initiation of breaks in the chip being produced.

It is also known to provide the cutting face with step chip breakers, and this is used with cutting inserts for machining tough and/or ductile materials almost exclusively. However, the geometry of these step chip breakers, which is designed to lead to breakage of the chips and to the smallest possible chip form with tool engagement, is involved in terms of efficiency with the feed, the stepping speed and the chip depth or chip thickness and is satisfactory only for specific machining criteria.

### SUMMARY OF THE INVENTION

The aim of the invention is now to create a cutting insert, in particular an indexable insert of the type mentioned at the outset, with which a formation of short chips in machining is achieved with normally long-chip materials. Furthermore, a formation of short chips is to take place largely independent of or in broad ranges of the machining criteria.

According to the invention, the cutting face and optionally the free surface(s) with a generic cutting insert has (have) at least in part a fine structure with convex and concave areas, whereby the areas of the fine structure projecting at the front and at the rear are spaced apart from one another by more than 0.1 mm and less than 1.0 mm.

The advantages achieved with the invention are to be seen essentially in that, largely irrespective of the shape of the cutting face, the fine structure of the same produces a frequent breaking of the chip removed from the workpiece. The reason for this has not yet been sufficiently explained in scientific terms, however, it can be assumed that the fine structure of the cutting faces leads to compressive stresses and deformations in the chip being produced, which lead to the initiation of chip breaks, even with tough material of the workpiece.

It was thereby ascertained, to the complete surprise of one skilled in the art, that in the hard use of a cutting insert according to the invention the new surface structure does not produce increased crater wear, in fact in most cases it is even reduced.

Furthermore, it was found that advantageously the heat transfer into the cutting insert is reduced and the durability of a coating is also increased and the abrasion in the area of the cutting face close to the cutting edge is reduced.

A particularly advantageous formation of short chips can be achieved in one embodiment of the invention in which the concave and convex areas of the fine structure are spaced apart from one another by less than 0.6 mm, in particular less than 0.4 mm.

If furthermore the depth of the fine structure or the perpendicular spacing between concave and convex areas of the surface structure is less than 1.0 mm, preferably less than 0.6 mm, in particular less than 0.4 mm, not only are abrasion and cratering of the cutting face reduced, but also chips of uniform shortness are favorably produced, which chips can be easily removed from the machining area of the machine.

Advantageously, the fine structure of the cutting face can be embodied as a uniform structure and favorably has a depth of at least 0.02 mm, preferably at least 0.04 mm. A production of the cutting insert with fine structuring of the cutting face can thus be simplified in stamping the greenbody and the durability of a coating and consequently the functionality of the cutting insert in high-performance cutting can be extended, whereby a production of short chips is not adversely affected.

If the fine structure is embodied essentially in a linear form or with a curved linear form, in addition to the formation of short chips, an effective, optionally directional, guiding of the chips can be achieved.

A fine structure of the cutting face of a cutting insert, which structure is essentially formed by intersecting respectively linear concave and convex areas, represents a structuring that is as homogenous as possible with a favorable chip-breaking effect from all directions of impingement and can be used universally.

For machining criteria of materials with which no built-up edge (built-up cutting edge) or no edge deposition takes place, it can be favorable for frequent chip breakage if the fine structure on the surface(s) starts directly from the cutting edge(s).

With respect to a high quality of the machined surface and a formation of short chips, it can be advantageous if the fine structure on the cutting face is formed with a spacing from the cutting edge of less than 1.0 mm, preferably less than 0.6 mm, in particular less than 0.4 mm and is continued further thereon.

For particularly ductile materials, it can be particularly advantageous in cutting if the fine structure is formed as a superstructure on the cutting face of a cutting insert, which cutting face is formed with step chip breakers or chip-breaker elevations. There can thus be beating effects in the mechanical action on the chip being produced which promote the formation of short chips despite unfavorable material prerequisites.

### BRIEF DESCRIPTION OF THE DRAWINGS

The invention is described in more detail on the basis of diagrammatic drawings of cutting insert images and the results of machining tests that respectively represent only one embodiment method.

They show:

FIG. 1 A plan view of a cutting insert according to the invention, in diagrammatic form or in a schematic representation;

FIG. 2 A side view of a cutting insert according to the invention, in diagrammatic form or in a schematic representation;

FIG. 3 A cross section of a cutting insert according to the invention, in diagrammatic form or in a schematic representation;

FIG. 4 A plan view of a test cutting insert according to the invention;

FIG. 5 A cross section of a test cutting insert according to the invention;

FIG. 6 Chip shapes with a workpiece machining using a conventional cutting insert; and

FIG. 7 Chip shapes with a workpiece machining using a cutting insert according to the invention.

### DETAILED DESCRIPTION OF THE INVENTION

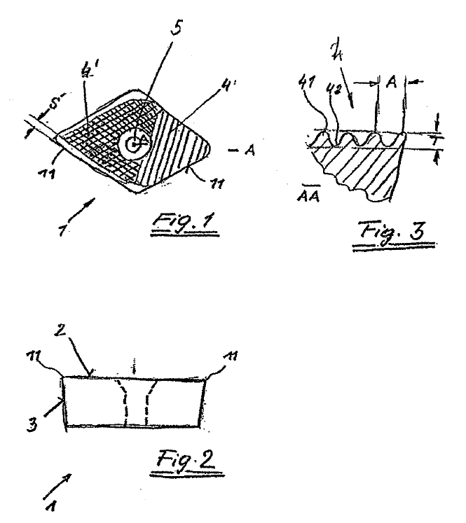

FIG. 1 shows in a schematic representation an indexable insert 1 according to the invention that can be fixed from above through a bore 5 on a clamp-type tool holder. FIG. 2 shows a view of the indexable insert 1 with cutting edges 11, free (or lateral) surfaces 3 and a cutting face 2.

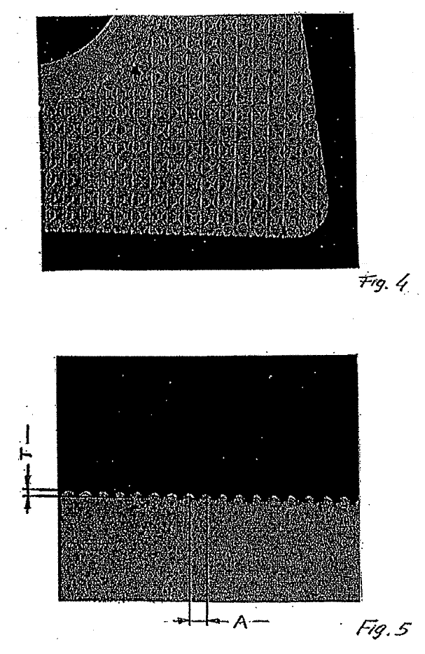

FIG. 1 shows fine structurings 4, 4′ of the cutting face 2 of the indexable insert 1 in diagrammatic form. On the right of the cutting face 2 an essentially linear or wavy fine structure 4 extends up to a cutting edge 11. FIG. 3 shows in a partial sectional representation AA of a cutting corner towards the mounting bore 5 that the fine structure 4 has convex areas 41 and concave areas 42, which areas are respectively spaced apart by a distance A. A depth of the fine structure T is characterized by the perpendicular distance T between the highest elevation of the convex area 41 and the base of the concave area 42.

A fine structure 4′ formed by intersecting, respectively linear concave 42 and convex 41 areas can be seen in the left part of the cutting face 2 of the indexable insert 1 according to FIG. 1. This fine structure 4′ is embodied spaced apart from the cutting edges on the cutting face 2, such that the cutting face 2 is free of structuring in a spacing S from the cutting edge 11.

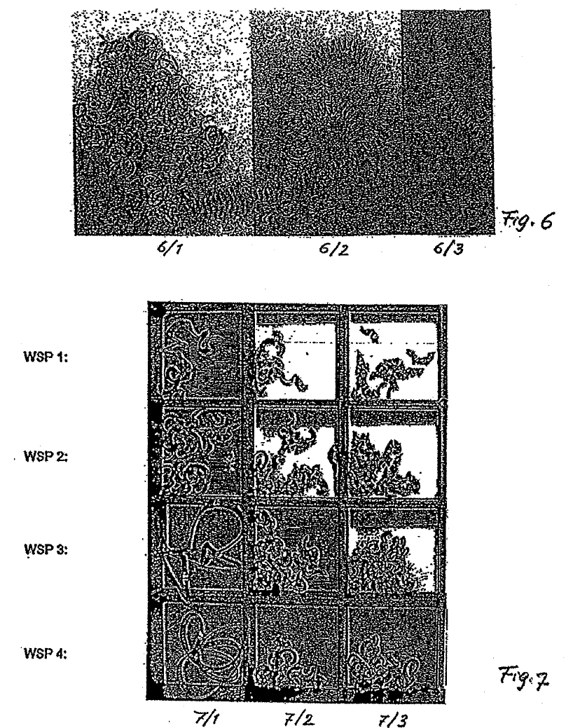

A cutting face of a test indexable insert is shown in plan view in FIG. 4, while a cross-section of the insert depicted in FIG. 4, is illustrated in FIG. 5. As shown, the cutting face is structured by fundamentally pyramid-shaped elevations with a spacing A of 0.4 mm and a depth T of 0.15 mm.

FIG. 6 shows turning chips removed from a workpiece of a material of the steel grade 34CrNiMo6, whereby a cutting insert with a flat unstructured cutting face was used. In the left image section 6/1 the chip form with a feed of 0.1 mm per workpiece revolution can be seen, in the center image section 6/2 the feed was 0.2 mm, whereby, as can also be seen from the right image section 6/3 (feed 0.3 mm), respectively a largely unbroken spiral chip was produced.

FIG. 7 shows shapes of turning chips that were produced in a machining of a workpiece of the same type (steel grade 34CrNiMo6) with indexable inserts according to the invention with structured cutting face.

The image sections 7/1, 7/2 and 7/3 show chips that were formed respectively with a feed per workpiece revolution of 0.1 mm, 0.2 mm and 0.3 mm. The designations WSP1, WSP2, WSP3 and WSP4 designate indexable inserts according to the invention with different fine structure of the cutting face as an experiment.

The cutting face of the indexable inserts WSP1 and WSP2 had a fine structure formed by intersecting linear concave and convex areas (WSP1) and by fundamentally evenly distributed pyramid-shaped elevations (WSP2).

The cutting face of the indexable inserts WSP3 and WSP4 respectively exhibited a linear form of the structure.

The advantages obtained with the invention of a formation of short chips effected by the tool with a turning machining of a cylinder are clarified by a comparison of the chip shapes, shown in FIG. 6, which were obtained with a use of an indexable insert according to the prior art and those, as shown in FIG. 7, which were produced with a use of indexable inserts according to the invention with structured cutting face.

1.-9. (canceled)

10. A cutting insert for tools for cutting workpieces or objects, comprising:
at least one cutting edge;
at least one lateral surface; and
at least one cutting face comprising a fine structure having convex and concave areas,
wherein the convex and concave areas, have a depth T and are respectively spaced apart from one another by a spacing A greater than 0.1 mm and less than 1.0 mm.

11. The cutting insert according to claim 10, wherein the cutting insert is an indexable insert.

12. The cutting insert according to claim 10, wherein at least a portion of the at least one lateral surface comprises a fine structure having convex and concave areas, wherein the convex and concave areas, have a depth T and are respectively spaced apart from one another by a spacing A greater than 0.1 mm and less than 1.0 mm.

13. The cutting insert according to claim 10, wherein the spacing A is less than 0.6 mm.

14. The cutting insert according to claim 13, wherein the spacing A is less than 0.4 mm.

15. The cutting insert according to claim 10, wherein the depth T is less than 1.0 mm.

16. The cutting insert according to claim 15, wherein the depth T is less than 0.6 mm.

17. The cutting insert according to claim 16, wherein the depth T is less than 0.4 mm.

18. The cutting insert according to claim 10, wherein the fine structure is at least one of structured and arranged having a uniform structure and having the depth T of at least 0.02 mm.

19. The cutting insert according to claim 18, wherein the depth T is at least 0.04 mm.

20. The cutting insert according to claim 10, wherein the fine structure is structured and arranged in one of an essentially linear form and a curved linear form.

21. The cutting insert according to claim 10, wherein the fine structure further comprises intersecting respectively linear concave or convex areas.

22. The cutting insert according to claim 10, wherein the fine structure starts from the at least one cutting edge.

23. The cutting insert according to claim 10, wherein the fine structure is spaced from the cutting edge by a spacing S of less than 1.0 mm

24. The cutting insert according to claim 23, wherein the spacing S is less than 0.6 mm.

25. The cutting insert according to claim 24, wherein the spacing S is less than 0.4 mm.

26. The cutting insert according to claim 10, wherein the fine structure is formed as a superstructure on the cutting face having one of step chip breakers and chip-breaker elevations.

27. A method of producing a cutting insert for tools for cutting workpieces or objects, comprising:
forming a fine structure having convex and concave areas in at least a cutting face of a cutting insert,
wherein the convex and concave areas, have a depth T and are spaced apart from one another by a spacing A greater than 0.1 mm and less than 1.0 mm.

28. The method of claim 27, further comprising forming a fine structure having convex and concave areas in at least one lateral surface of the cutting insert,
wherein the convex and concave areas, have a depth T and are spaced apart from one another by a spacing A greater than 0.1 mm and less than 1.0 mm.

29. The method of claim 27, wherein the forming of the fine structure comprises stamping the at least one cutting face to form the fine structure.
